(19) United States
(12) Patent Application Publication
(10) Pub. No.: US 2009/0144776 A1
(43) Pub. Date: Jun. 4, 2009

(54) Support for Personal Content in a Multimedia Content Delivery System and Network

(75) Inventors: Edward A. Walter, Boerne, TX (US); Larry B. Pearson, San Antonio, TX (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 11/947,524

(22) Filed: Nov. 29, 2007

(51) Int. Cl. G06F 3/00

(52) U.S. Cl. 725/47

(57) ABSTRACT

A disclosed set top box (STB) suitable for use in presenting multimedia content is operable to receive multimedia content from a provider content source that is remotely connected to the STB via a provider network. The STB is also operable to receive multimedia content from a personal content source. The personal content source is locally connected to the STB or connected to the STB via a public network. The STB is operable to identify a channel indicated by a remote control signal and determine whether the indicated channel is a provider content channel or a personal content channel. The STB streams multimedia content from the first source when the indicated channel is a provider content channel and from the personal source when the indicated channel is a personal channel. The content from the provider content source and the personal content may be received through different STB interfaces. The personal content may be received from a locally connected source.

### BACKGROUND

1. Field of the Disclosure

The present disclosure relates to multimedia content delivery systems and networks.

2. Description of the Related Art

The prevalence of camcorders and other similar devices has resulted in an abundance of personal multimedia content or, more simply, personal content. Personal content is rarely integrated in any way with content delivered by a provider of television, video-on-demand, pay per view, and other multimedia services.

### BRIEF DESCRIPTION OF THE DRAWINGS

FIG. 1 is a block diagram of selected elements of an embodiment of a multimedia content network;

FIG. 2 is a block diagram of selected elements of an embodiment of a set top box employed in some embodiments of the network of FIG. 1;

FIG. 3 is a diagram of selected software modules employed in some embodiments of the set top box of FIG. 2;

FIG. 4 is a diagram of a mapping module employed in some embodiments of the set top box of FIG. 2;

FIG. 5 is a flow diagram illustrating selected elements of the operation of an embodiment of the mapping module of FIG. 3;

FIG. 6 is a flow diagram illustrating selected elements of a method of integrating personal multimedia content and provider multimedia content;

FIG. 7 illustrates an exemplary electronic programming guide screen; and

FIG. 8 illustrates an exemplary personal content screen.

### DESCRIPTION OF THE EMBODIMENT(S)

In one aspect, a disclosed set top box (STB) suitable for use in playing or otherwise presenting multimedia content includes STB storage and a processor operable to access the STB storage. An interface of the STB is operable to receive multimedia content from a provider content source via a provider network. An interface of the STB is operable to receive multimedia content from a personal content source. The provider content interface and the personal content interface may be the same physical interface or they may be physically distinct interfaces. The provider content interface, for example, may be a coaxial or Ethernet interface and the personal content interface may be an Ethernet or a serial bus interface. The STB includes a remote control interface for receiving a remote control signal from a remote control device. The STB is operable, via executable instructions embedded in the STB storage, to identify a channel indicated by the remote control signal and determine if the identified channel is a provider content channel or a personal content channel. If the identified channel is a provider content channel, the STB streams multimedia content from the provider content source to a display device. If the identified channel is a personal content channel, the STB streams multimedia content from the personal content source to the display device.

Receiving multimedia content from the provider content source may include receiving a composite signal containing a plurality of multimedia content streams. In these embodiments, streaming multimedia content to the display includes filtering the composite signal to extract a multimedia content stream corresponding to the identified channel.

The STB may be further operable to detect an electronic programming guide (EPG) signal from the remote control and respond by generating and/or displaying an EPG screen that includes a personal content portion. The EPG screen may include a plurality of rows representing a plurality of provider content channels. The personal content portion may be a row in the EPG representing a personal content channel. Selecting the personal content channel from the EPG screen may cause the STB to retrieve personal content library information from the personal content source and generate a personal content screen from the personal content library information where the personal content screen displays titles of multimedia content items accessible from the personal content source. The STB may also detect remote control selection of a title displayed in the personal content screen and retrieve and stream the corresponding multimedia content item to the display device.

In another aspect, a disclosed computer program product includes instructions, stored on the STB storage or another computer readable medium, for selecting multimedia content. The instructions include instructions for storing provider electronic EPG data received from a network connected provider content source and personal content library data received from a personal content source. The personal content library data reflects items of personal multimedia content stored in or otherwise accessible from the personal content source. The instructions include instructions for detecting an EPG signal and generating an EPG screen based on the provider EPG data. The EPG screen includes a row or other portion representing a personal content channel. The instructions include instructions to respond to detecting selection of the personal content channel from the EPG screen by generating a personal content screen based, at least in part, on the personal content library data. The personal content screen displays personal content titles corresponding to items of personal multimedia content. The instructions may further include instructions for selection of a personal content title from the personal content screen by streaming the respective personal content item to the display device. The instructions may include instructions to detect a download signal and respond by storing an item of personal multimedia content to the STB storage.

In another aspect, a disclosed method of provisioning a STB includes enabling the STB to receive EPG data from a provider network, receive personal content library data from a personal content source, and respond to an EPG signal by generating an EPG screen depicting a plurality of provider content channels and at least one personal content channel. The method may further include enabling the STB to respond to detecting selection of the personal content channel from the EPG screen by generating a personal content screen indicative of titles of respective items of personal multimedia content and respond to detecting selection of a title from the personal content library by streaming a respective item of personal multimedia content item to the display device.

In the following description, details are set forth by way of example to facilitate discussion of the disclosed subject matter. It should be apparent to persons of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 102-1 refers to a particular instance of a widget class and the class may be referred to collectively as widgets 102 while any one of the widgets may be referred to generically as a widget 102.

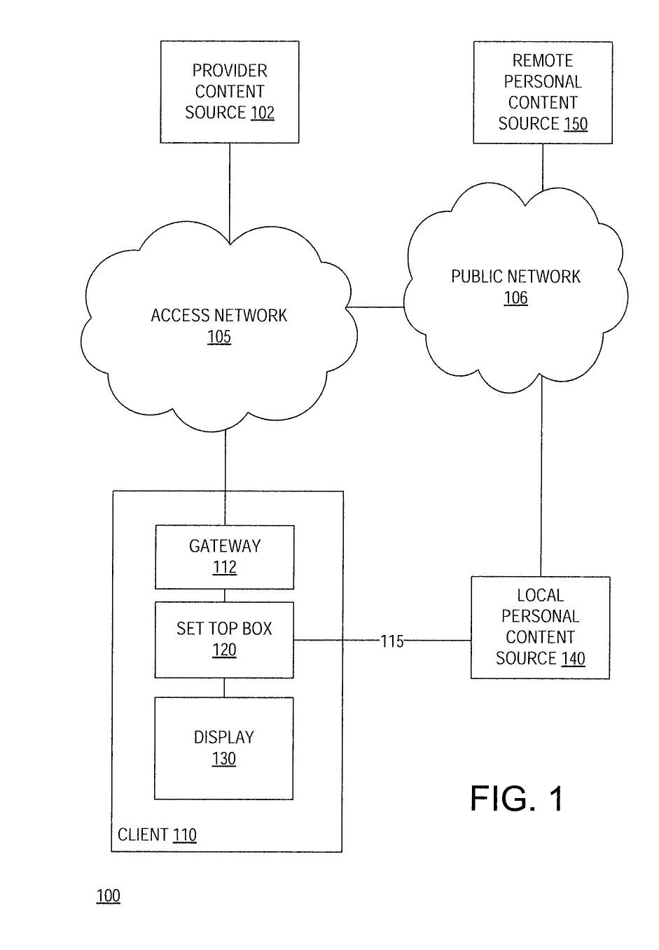

Referring now to the drawings, FIG. 1 depicts selected elements of an embodiment of a multimedia content delivery network 100 that enables and supports integration of personal content and provider content. In the depicted embodiment, multimedia content delivery network 100 includes a client 110 operably connected to a source of provider-supplied multimedia content, referred to herein as provider content source 102, and sources of personal multimedia content, including a local personal content source 140 and a remote personal content source 150. Although FIG. 1 depicts local and remote sources of personal content, other embodiments may omit one or the other source of personal content.

As depicted in FIG. 1, client 110 is connected to provider content source 102 via an access network 105 and to a local personal content source 140 via a local interconnection 115. In some embodiments, access network 105 is a component of a private network administered by a provider of multimedia delivery services. Multimedia delivery services may include television, video-on-demand, and pay-per-view services delivered to a local, regional, or national group of subscribers by the service provider.

In some embodiments, access network 105 includes a physical medium of twisted pair or fiber optic cables. In other embodiments, the physical medium for access network 105 is coaxial cable or another physical medium suitable for delivering multimedia content. Depending upon the implementation, access network 105 may be a cable-based multimedia content delivery network or an IP-based multimedia content delivery network. Access network 105 may include gateways or other devices suitable for implementing firewalls (not depicted) that demarcate access network 105 from other private networks and from public networks such as the Internet.

Local interconnection 115 may be implemented as a wireline Local Area Network (LAN) interconnection, e.g., an IEEE 802.3 (Ethernet) compliant interconnection. In other embodiments, local interconnection 115 may be a wireless LAN interconnection, e.g., an IEEE 802.11 (WiFi) interconnection. In still other embodiments, local interconnection 105 is a serial-type interconnection, e.g., a Universal Serial Bus (USB) compliant interconnect.

Client 110 as shown is also connected to remote personal content source 150 via access network 105 and public network 106, which may represent or include the Internet and/or another public network. In the depicted embodiment, local personal content source 140 is shown as being connected to remote personal content source 150 via public network 106.

In the depicted embodiment, client 110 includes an optional gateway 112, STB 120 and a display device 130. Gateway 112 may be used in implementations that employ an IP-based access network 105 including, for example, Internet Protocol Television (IPTV) provider networks. In these embodiments, gateway 112 may be implemented, for example, as a conventional digital subscriber line (DSL) or other type of broadband modem connected to or integrated with a LAN router/access point. In other embodiments including, for example, traditional cable-based provider networks, STB 120 may be directly connected to the access network 105 and gateway 112 may be omitted.

In embodiments suitable for use in North America, Japan, the Philippines, South Korea, Taiwan, and certain other jurisdictions, display device 130 is a National Television System Committee (NTSC) compliant display device. In other jurisdictions, display device 130 may be a Phase Alternating Line (PAL) compliant display device.

Local personal content source 140 represents substantially any device capable of storing multimedia content and transmitting the stored content over a wireline or wireless interconnect. Thus, for example, local personal content source 140 may be implemented with a variety of data processing and data storage devices including desktop or laptop personal computers (PCs), Personal Digital Assistants (PDAs) and other network-aware communication devices, tablet PCs, digital cameras and camcorders, thumb drives and so forth.

Provider content source 102 represents any suitable source of multimedia content delivered by the provider. Thus, provider content source 102 may represent or include national and regional television feeds, broadcast television content, video-on-demand content, pay per view content, and so forth. Provider content source 102 encompasses implementations that employ regional distribution centers connected to a central or national office by a fiber optic backbone. The regional centers may acquire national content from the national office and regional content from regional broadcasters.

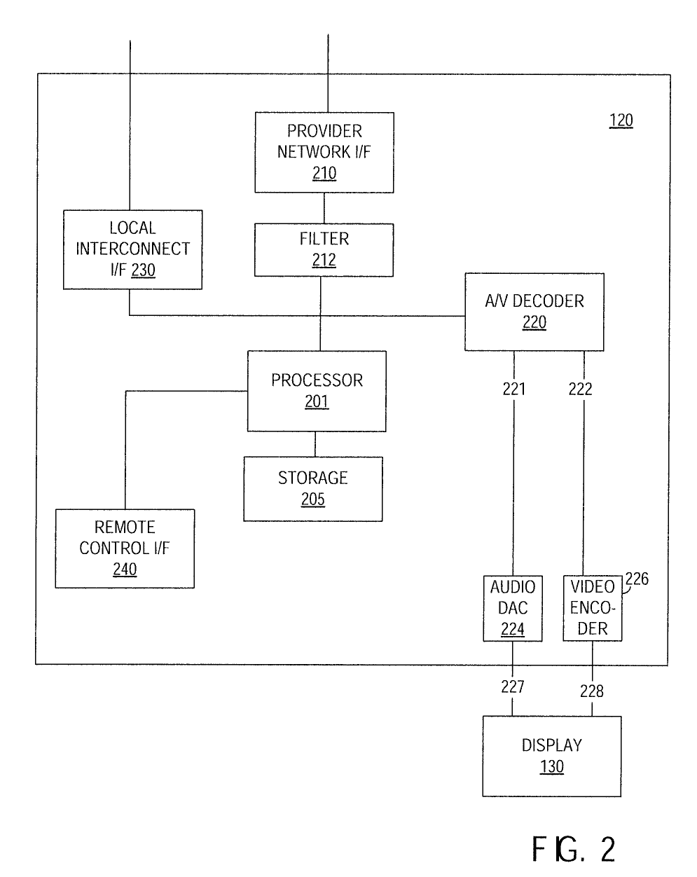

FIG. 2 depicts selected elements of an embodiment of STB 120. In the depicted embodiment, STB 120 includes an embedded or general purpose processor 201 connected to and operable to access a storage resource 205. Storage resource 205 may include various storage media including persistent storage media such as hard disks, flash memory, and optical storage media including CDs and DVDs, as well as volatile memory resources including Random Access Memory (RAM) elements.

STB 120 as depicted further includes a local interconnect interface 230, a provider network interface 210, and an optional filter 212, all of which are operably connected to processor 201 and to an Audio % Video decoder 220. STB 120 may also include a remote control interface 240 operably connected to processor 201. Remote control interface 240 receives and decodes remote control signals containing encoded remote control commands transmitted by a remote control device. Remote control interface 240 is operable to communicate the remote control commands to processor 201. In some embodiments, remote control interface 240 is operable to receive infrared (IR) signals or radio frequency (RF) signals. STB 120 may further include front panel buttons (not depicted) or other suitable manual means for generating remote control signals.

Audio/video decoder 220 as shown may be an MPEG-2 or other suitable type of decoder capable of producing an audio stream 221 and a video stream 222. An audio digital-to-analog converter (DAC) 224 receives audio stream 221 from decoder 220 and provides an audio signal 227 to display device 130 while a video encoder 226 receives video stream 222 and generates a video signal 228 in a suitable format, e.g., NTSC or PAL, for use by display device 130.

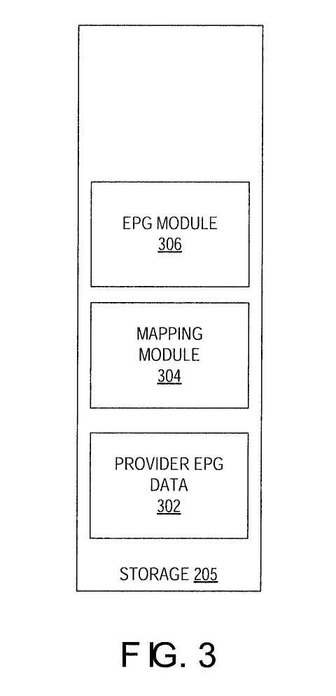

FIG. 3 depicts selected software elements of certain embodiments of STB Storage 205. In the depicted implementation, the STB storage 205 includes a data structure referred to as provider EPG data 302 and software modules including a mapping module 304 and an EPG module 306. Provider EPG data 302 may be downloaded from provider content source 102 or another provider managed resource via access network 105 from time to time either in response to a request from STB 120 or by being automatically “pushed” across access network 105 by the provider. Provider EPG data 302 includes time-of-day and channel information for multimedia content titles delivered via access network 105. Provider EPG data 302 may further include additional metadata including descriptive information about the multimedia content titles.

In some embodiments, mapping module 304 is operable to map a source of personal content, whether it be a local or remote personal content source, to a particular STB channel. Mapping module 304 enables STB 120 to respond to a user selection of the channel assigned to personal multimedia content by playing personal multimedia content or by presenting a personal content screen from which the user may select content to be played.

EPG module 306 is operable to access provider EPG data 302 as well as any information regarding the mapping of a personal content channel, to generate an EPG screen for display. The EPG screen generated by EPG module 306 beneficially includes, in addition to a plurality of channels corresponding to provider supplied content, at least one channel that corresponds to a local or remote personal content source. In some embodiments, EPG module 306 may be further operable to generate and present screens that display information regarding personal content including, for example, a screen displaying a list of personal content titles where each title corresponds to a personal content item and each personal content item is a video or other form of multimedia content.

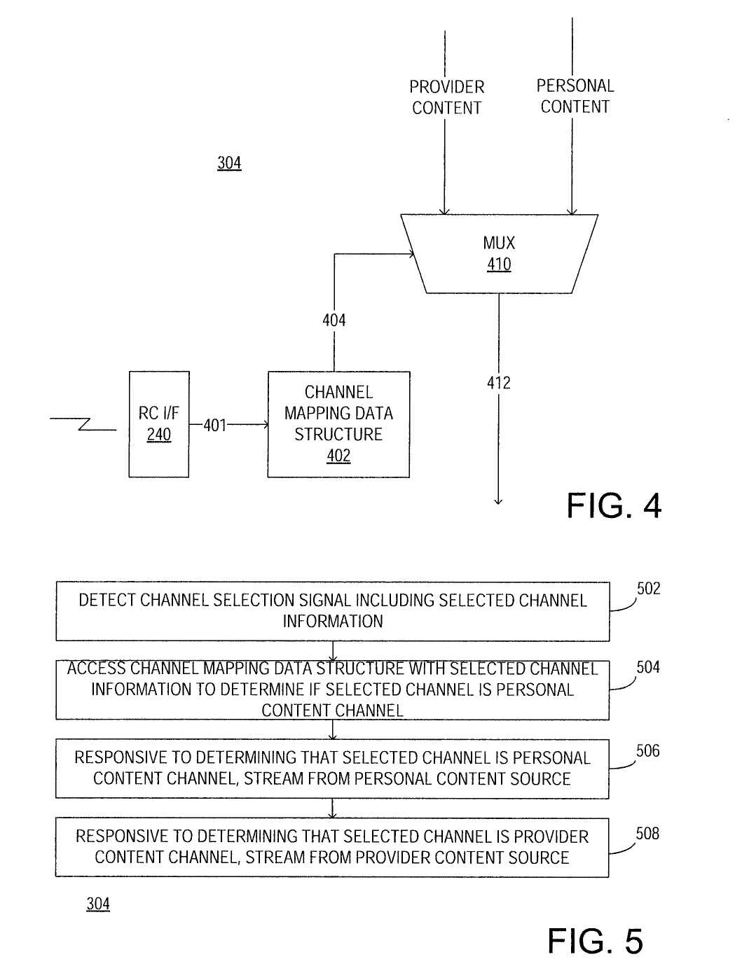

FIG. 4 illustrates an embodiment of mapping module 304 as implementing a multiplexer function to select between personal and provider content sources. As depicted in FIG. 4, mapping module 304 responds to an output 401 from remote control interface 240. When the output 401 indicates the user has selected a particular channel via the remote control or via a front panel button, the output is used to index a channel mapping data structure 402. The data structure 402 outputs a multiplexer control signal 404 that determines whether multiplexer 410, which is operable to receive content from the personal content source and the provider content source, passes the personal content or the provider content to the display device via the multiplexer output 412.

FIG. 5 is a flow diagram representing an embodiment of mapping module 304. As depicted in FIG. 5, mapping module 304 detects (block 502) a channel selection signal that includes information indicative of the channel selected by the remote control user. The channel mapping data structure 402 is then accessed (block 504) to determine if the selected channel is a personal content channel or a provider content channel. If the selected channel is a personal content channel, personal content is streamed (block 506) to the display device. If the selected channel is a provider content channel, provider content is streamed (block 508) to the display device.

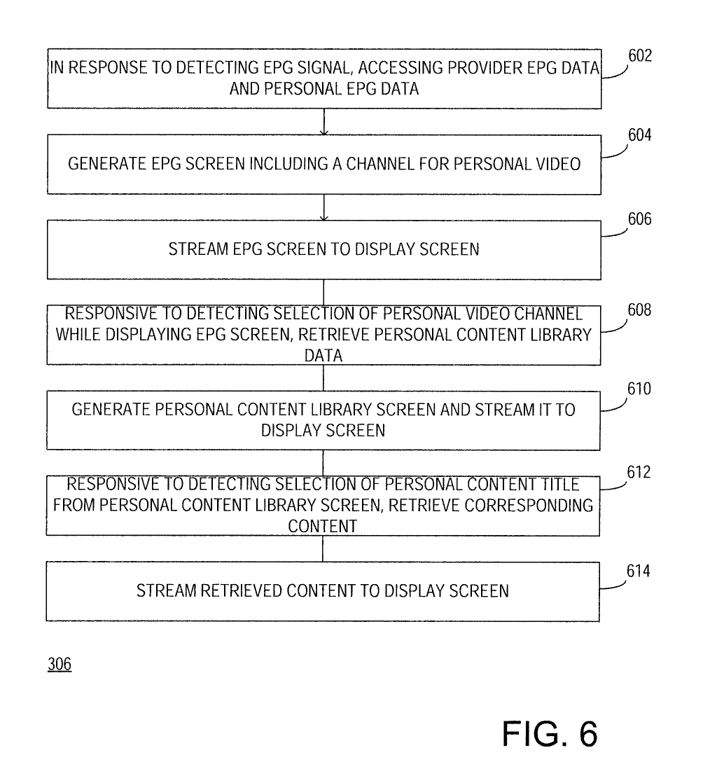

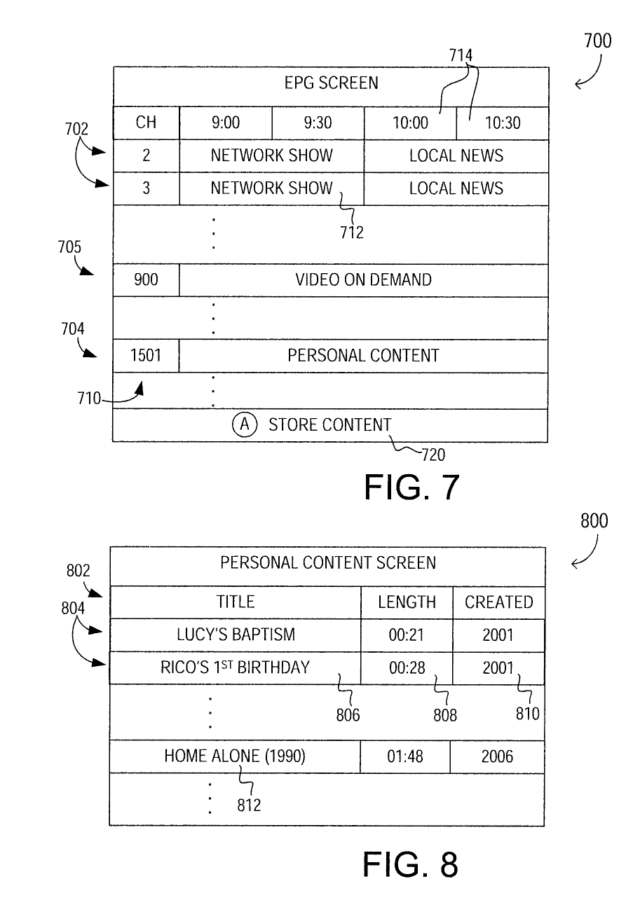

FIG. 6 is a flow diagram illustrating an embodiment of EPG module 306. EPG module 306 as implemented in the embodiment depicted in FIG. 6 includes accessing (block 602) the provider EPG data 302 in response to detection of an EPG signal. The EPG signal may be generated in various ways including, for example, when a user asserts or activates a dedicated or soft coded EPG button of a remote control device or STB front panel. Block 602 may also include retrieving personal EPG from the personal content source. In some implementations, such as implementations in which the personal content is entirely or largely time-shifted content analogous to video-on-demand content, the EPG screen itself may be generated with little or no specific information about the personal content, other than the channel(s) mapped to personal content. Channels that are mapped to time-shifted content, including personal content channels, may be presented in the EPG screen without reference to individual content titles as shown in the exemplary EPG screen depicted in FIG. 7, described below.

In response to detecting an EPG signal, the depicted embodiment of EPG module 306 generates (block 604) an EPG screen that includes a selectable object representing the personal content source. In embodiments that generate an EPG screen that depicts the provider supplied channels as rows in an EPG table, the selectable object representing the personal content source may be an additional row, representing the channel in the EPG table to which the personal content source is mapped.

In some embodiments, the EPG screen itself is a multimedia object that can be streamed (block 606) to the display device so that the EPG screen is visible to the user. An exemplary EPG screen 700 is depicted in FIG. 7. As depicted in FIG. 7, EPG screen 700 is presented as a table that includes a set of rows 702 where each row 702 represents a provider supplied channel of content. EPG screen 700 further includes at least one row 704 representing a respective source of personal content as a separate channel. Each row 702 in EPG screen 700 may include several columns of information including, for example, a channel column 710 indicating the channel number that is mapped to the content displayed in the row. The depicted EPG screen 700 further includes time of day indicators 714 indicating the time of day when content begins and ends. The content titles, e.g., content title 712, are positioned so that the beginning time and ending time are aligned to the time of day indicators 714. For channels that correspond to time-shifted content including, for example, personal content channel 704 and video-on-demand channel 705, the time of day indicators 714 may be of less relevance because the content delivered through the time-shifted channels may be requested at any time. Each of the content titles 712 may itself be a selectable object. In some embodiments, selection of a content title from the EPG screen 700 may display additional information regarding the content title. The additional information might include a plot summary, a partial list of the actors, director, etc., the year of release for movies, and so forth.

EPG screen 700 as shown in FIG. 7 also includes a selectable object 720 corresponding to stored content. STB 120 may include Digital Video Recording (DVR) functionality that permits the user to record and store content in STB storage 205. In these embodiments, activating the selectable object 720 may result in the display of a stored content library indicating titles of stored content. DVR functionality may be leveraged beneficially in multimedia content delivery network 100 to upload personal content from local personal content source 140 to STB storage 205. In this embodiment, a user, when accessing the personal content channel, may select a title and respond to a resulting query by indicating that the user wishes to upload the selected title to STB storage 205 where the content will then be available to the user from within STB 120 itself.

Returning to FIG. 6, EPG module 306 as shown includes retrieving (block 608) personal content library data from a personal content source in response to detecting the selection of a personal content channel from the EPG screen. The personal content library data includes information indicating a title and, optionally, other information regarding multimedia content stored in local personal content source 140 and/or remote personal content source 150. The titles for personal content may be user selected when the user stores multimedia content to the personal content source. The personal content library data may be retrieved at the time the user selects a personal content channel from the EPG screen or pre-retrieved from time to time by STB 120 and/or EPG module 306.

EPG module 306 as depicted in FIG. 6 is operable to generate (block 610) a personal content screen based on the personal content library data and stream the personal content screen to the display device. An exemplary personal content screen 800 is depicted in FIG. 8. Personal content screen 800 as shown in FIG. 8 is a table that includes a heading row 802 and a set of content rows 804.

Each content row 804 corresponds to a personal content item stored in the personal content source. Each content row 804 of personal content screen 800 may include a title block 806, a running time block 808, and a date block 810. Title block 806 indicates a title of the corresponding content item that was assigned by the user when the item was stored to the personal content source. Alternatively, content items may be stored without a title, in which case, title information may be subsequently associated with content items as part of EPG module 306 or as part of a standalone application.

The running time block 808 indicates the approximate length of the corresponding content item. The running time value may be estimated based on the size of the content item, determined based on a real time clock during a first or subsequent playing of the content item, or be appended to the content item by a user manually. The created block 810 may include a time stamp or other indication of the month, day, and/or year when the corresponding content item was created. Although FIG. 8 depicts personal content screen 800 as including certain specified fields of information, other embodiments may employ more, fewer, and/or different fields of information. Personal content screen 800 illustrates that, while some of the content items stored as personal content are content items personal to the user such as family events, personal content items may also include personal copies of commercially distributed content items including, for example, the commercially distributed movie identified in row 812.

Returning to FIG. 6, the depicted embodiment of EPG module 306 includes retrieving (block 612) a personal content item from the personal content source in response to detecting a user selection of a title from the personal content screen. Retrieval of content may be done by downloading the entire content item to a permanent or temporary portion of STB storage 205, or by downloading the content item to a temporary portion of STB storage 205 in blocks of sufficient size to enable play back of the content items without interruption, pause, or delay. The retrieved content may then be streamed (block 614) to the display device for play back. In some embodiments, the retrieval of content in block 614 is optional in the sense that content is not stored in STB storage 205. Instead, the content is streamed directly from the personal content source to the display device 130 via STB 120.

The above disclosed subject matter is to be considered illustrative, and not restrictive. The appended claims encompass modifications, enhancements, and other embodiments that would be readily envisioned by one of ordinary skill having the benefit of this disclosure.

What is claimed is:

1. A set top box including set top box storage and a processor operable to access the set top box storage, comprising:
an interface for receiving multimedia content from a provider content source via a provider network;
an interface for receiving multimedia content from a personal content source;
a remote control interface for receiving a remote control signal from a remote control device; and
executable instructions embedded in the set top box storage, the instructions including instructions to:
identify a channel indicated by the remote control signal;
responsive to the identified channel matching a provider content channel, streaming multimedia content from the provider content source; and
responsive to the identified channel matching a personal content channel, streaming multimedia content from the personal content source.

2. The set top box of claim 1, wherein the receiving of multimedia content from the provider content source includes receiving a composite signal comprising a plurality of multimedia content streams and wherein streaming multimedia content to the display includes filtering the composite signal to extract a multimedia content stream corresponding to the identified channel.

3. The set top box of claim 1, wherein the interface for receiving the provider content is a coaxial cable interface.

4. The set top box of claim 1, wherein the interface for receiving the provider content is a local area network interface.

5. The set top box of claim 4, wherein the local area network interface is an Ethernet interface and wherein the provider content source is connected to the set top box through an intervening gateway locally connected to the set top box.

6. The set top box of claim 1, wherein the interface for receiving the personal content is a serial bus interface and wherein the personal content source is locally connected to the set top box.

7. The set top box of claim 1, wherein the remote control interface is an infrared interface.

8. The set top box of claim 1, further comprising instructions to detect an electronic programming guide (EPG) signal from the remote control and, in response, display an EPG screen wherein the EPG screen includes a personal content portion.

9. The set top box of claim 8, wherein the EPG screen includes a plurality of provider content channels and wherein the personal content portion comprises at least one personal content channel.

10. The set top box of claim 8, further comprising instructions to:
retrieve personal content library information from the personal content source; and
stream the personal content library information to the display device wherein the personal content library information is indicative of multimedia titles stored in a personal content library locally accessible to the personal content source.

11. The set top box of claim 10, further comprising instructions to:
detect remote control selection of a personal content title displayed in the personal content library information; and
retrieve personal content associated with the selected personal content title and stream the retrieved personal content to the display device.

12. A computer program product comprising instructions, stored on a computer readable medium, for selecting multimedia content, the instructions comprising instructions for:
storing provider electronic programming guide (EPG) data received from a network connected provider content source and personal content library data received from a locally connected personal content source, wherein the personal content library data is indicative of personal content stored in the personal content source;
responsive to detecting an EPG signal, generating an EPG screen based on the provider EPG data wherein the EPG screen includes a personal content channel;
streaming the EPG screen to the display; and
responsive to detecting selection of the personal content channel from the EPG screen, generating a personal content screen based, at least in part, on the personal content library data, wherein the personal content screen displays personal content titles corresponding to respective personal content items.

13. The computer program product of claim 12, further comprising instructions to respond to detecting selection of a personal content title from the personal content screen by streaming the respective personal content item to the display device.

14. The computer program product of claim 12, further comprising instructions to respond to determining that a received channel selection signal corresponds to the personal content channel by streaming the personal content screen to the display device.

15. The computer program product of claim 12, further comprising instructions to respond to detecting a directional signal while the EPG screen is displaying by modifying a portion of the EPG screen being displayed.

16. The computer program product of claim 12, further comprising instructions to respond to detecting a download personal content signal by retrieving a selected personal content item from the personal content source and storing the personal content source in set top box storage.

17. A method of provisioning a set top box comprising enabling the set top box to:
receive provider electronic programming guide (EPG) data from a provider network;
receive personal content library data from a personal content source;
respond to an EPG signal by generating an EPG screen depicting a plurality of provider content channels and at least one personal content channel;
respond to detecting selection of the personal content channel from the EPG screen by generating a personal content screen indicative of titles of respective personal content items; and
respond to detecting selection of a title from the personal content library by streaming a respective personal content item to a display device.

18. The method of claim 17, wherein the personal content source includes a data storage medium connect to the set top box via a local interconnect.

19. The method of claim 17, wherein the local interconnect is a Universal Serial Bus interconnect.

20. The method of claim 17, wherein the respective personal content item comprises a multimedia personal content item.

21. The method of claim 17, further comprising enabling the set top box to retrieve a personal content item from the personal content source and store the personal content item in set top box storage.

22. The method of claim 21, further comprising enabling the set top box to generate a screen indicative of content stored in the set top box storage.
